(19) United States
(12) Patent Application Publication
(10) Pub. No.: US 2024/0033962 A1
(43) Pub. Date: Feb. 1, 2024

(54) CONVERTING MACHINE WITH AUTOMATIC REWINDING COIL CHANGE

(71) Applicant: IMS TECHNOLOGIES S.P.A., Calcinate (IT)

(72) Inventors: Maurizio ARMITANO, Calcinate (IT); Isidoro BIANCHI, Calcinate (IT); Daniele ROTA, Calcinate (IT)

(21) Appl. No.: 18/357,885

(22) Filed: Jul. 24, 2023

(30) Foreign Application Priority Data
Jul. 26, 2022 (IT) 102022000015687

(51) Int. Cl. B26D 1/22; B26D 7/01

(52) U.S. Cl. CPC B26D 1/225; B26D 7/015; B26D 2210/11

(57) ABSTRACT

The present invention relates to a converting machine, i.e., a machine for winding or unwinding a strip of material on coils, particularly configured to process a delicate material.

In particular, the invention is directed to a machine (1) for converting coils of a material into smaller coils, comprising a loading unit (2) for loading a strip (N) of material into the machine (1), an accumulation unit (3) of the strip (N) being processed, and a winding unit (4) of the strip (N) on a winding shaft (5, 5′) to form respective coils (B), characterized in that the winding unit (4) comprises:
a revolving disc (29), which supports two winding shafts (5, 5′) of coils (B);
a feeding roller (30) of the strip (N) to a winding position;
a movable accompanying member (31) of the strip (N) and a cutting member (32) operatively associated with said feeding roller (30),
wherein the feeding roller (30), the movable accompanying member (31), and the cutting member (32) are placed on a carriage (33), movable horizontally between at least one forward or operating position and a retracted or resting position;
and wherein the movable accompanying member (31) and the cutting member (32) are hinged on the axis of the feeding roller (30) and are tiltable between a non-operating position and an operating position adapted to operate the crosswise cut of the strip M.

### FIELD OF THE INVENTION

The present invention relates to a converting machine, i.e., a machine for winding or unwinding a strip of material on coils, particularly configured to process a delicate material.

### Background Art

The field of converting relates to all machines performing a process of winding and unwinding a strip of material onto and from coils. Such machines perform the function of transporting the strip between one coil and another of generally different sizes in a fast and defect-free manner.

Such converting operations can consist in i) producing coils of small widths and diameters from parent coils produced in large sizes for reasons of process economy; ii) processing the material to add certain features, such as printing, lamination, or film deposition; and iii) rewinding a previously produced coil to eliminate defects.

The end product of the process is an intermediate step in the processing chains of all materials, such as paper, plastics, aluminum, and laminates, made in the form of films, generally of a thickness between a few microns and one millimeter. Converting machines are used in multiple industrial fields, including the food packaging and automotive industries, for example.

However, in some application fields, a highly delicate and/or brittle, very thin and/or loosely cohesive, and thus easily flaky, material needs to be subjected to converting. In these cases, managing the converting activity can be problematic and negatively affect the operational speed of the entire process.

A problem generally characterizing the converting machines is the difficulty in automating the change of the rewinding coil, which, being smaller than the feeding reel, must be changed during the processing. Such a change can occur without interrupting the process when a buffer section is arranged upstream, but still normally requires substantial human intervention. The same problem occurs when the strip tears (as is the case when the material is particularly brittle or delicate), so the winder must be changed and the rewinding must be restarted.

The need is thus felt to provide a machine for converting coils, especially but not solely coils of delicate and/or brittle material, which preserves high productivity and minimizes possible interruptions caused by material breakage and performs all the converting steps automatically.

### SUMMARY OF THE INVENTION

Such a problem is solved by a machine for converting coils of delicate and/or brittle material as defined in the appended claims, the definitions of which are an integral part of the present description.

In particular, the invention relates to:
1) a machine for converting coils of a material into smaller coils, comprising a loading unit for automatically loading a strip of material into the machine, an accumulation unit of the strip being processed, and a winding unit of the strip on a winding shaft to form respective coils, characterized in that the winding unit comprises:
a revolving disc, which supports two coil winding shafts;
a feeding roller of the strip to a winding position;
a movable accompanying member of the strip and a cutting member operatively associated with said feeding roller,
wherein the feeding roller, the movable accompanying member, and the cutting member are placed on a carriage, movable horizontally between at least one forward or operating position and a retracted or resting position;
and wherein the movable accompanying member and the cutting member are hinged on the feeding roller axis and are tiltable between a non-operating position and an operating position adapted to operate the crosswise cut of the strip;
2) a machine according to 1) wherein the movable accompanying member comprises a body having an arc-of-circle-shaped recess of shape and size such as to be coupled to an at least semi-cylindrical portion of the surface of a winding shaft;
3) a machine according to 2), wherein the recess comprises a housing which develops along its entire extension and in which an accompanying element of the strip slides, the accompanying element being movable between a retracted position and an extended position, in which, by sliding in said housing, it performs a rotation of about 180° about a rotation axis parallel to the rotation axis of the winding shafts;
4) a machine according to 3), wherein the accompanying member comprises a semicircular portion having a first end and a second end, a hinge being placed in an intermediate position between said ends, on which hinge a retaining element is hinged, comprising, in turn, an arc-of-circle-shaped portion and a protruding portion, which extends along a direction substantially perpendicular to a tangent of the arc-of-circle-shaped portion, wherein a holding roller is placed at the junction point between said arc-of-circle-shaped portion and said protruding portion, and an idle roller is placed at the distal end of the protruding portion; and wherein the protruding portion comprises a suction/blowing grille, which is alternately in flow communication with suction means or with a fan or source of compressed air; the retaining element being tiltable between a retracted position and a lowered position, in which the arc-of-circle-shaped portion of the retaining element coincides with a sector of the semicircular portion of the accompanying element;
5) a machine according to any one of 2) to 4), wherein the accompanying member comprises a tilting arm which distally comprises a holding roller and which is movable between a non-operating position and an operating position, in which the holding roller insists on a winding shaft;
6) a machine according to any one of 1) to 5), wherein the cutting member comprises a blade located on a side of the cutting member which, in an operating condition, faces the movable accompanying member and is configured to abut on a surface of the latter when cutting the strip;
7) a machine according to 6), wherein the cutting device comprises a body which extends along a longitudinal axis and comprises a holding roller at one end and, adjacent thereto, a cutting device, which protrudes along a direction substantially perpendicular to the body and carries said blade at its distal end;
8) a machine according to any one of 1 to 7, wherein the carriage comprises a tilting arm carrying a holding roller at one end, the tilting arm being movable between a non-operating position and an operating position in which the holding roller abuts against the feeding roller;
9) a machine according to any one of 1) to 8), wherein the carriage comprises a longitudinal strip cutting assembly, configured to cut the strip fed to the winding unit according to its length, so as to reduce its width and ultimately obtain two or more coils of rewound material, said longitudinal cutting assembly comprising a crosswise supporting bar comprising one or more cutting devices, wherein each cutting device comprises a vertically sliding blade, the blade preferably being a discoidal blade rotating in an idle manner, and wherein the crosswise supporting bar is movable along a track arranged diagonally on the carriage, between a raised position and a lowered position, the longitudinal cutting assembly further comprising a contrast cylinder, on which the strip is intended to slide and which, in operating condition, is tangential with the blade of the cutting device;
10) a machine according to any one of 1) to 9), wherein the winding unit comprises an idle roller placed laterally and at a higher position with respect to the feeding roller, said idle roller being configured to outline a path of the strip, or of the plurality of strips originated by the longitudinal cutting unit, so that it faces the accompanying member and is included between the latter and the cutting member;
11) a machine according to any one of 4) to 10), wherein the feeding roller and the winding shafts are motorized and wherein the movements of accompanying member, accompanying element, tilting arm, retaining element and cutting member are actuated by electric or pneumatic actuators.

Further features and advantages of the present invention will become more apparent from the description of some exemplary embodiments thereof, given below by way of non-limiting indication, with reference to the enclosed figures.

### BRIEF DESCRIPTION OF THE DRAWINGS

FIG. 1 is a diagrammatic side section view of the machine according to the present invention;

FIG. 2 is a diagrammatic side section view of the winding unit of the strip according to the present invention;

FIG. 3 is a perspective view of a detail of the strip winding unit according to the invention;

FIG. 4 shows the view in FIG. 2 in a different operating condition;

FIGS. 5-13 are diagrammatic side section views of the automatic changing system of the strip coil of the machine in FIG. 1, according to an operational sequence.

### DETAILED DESCRIPTION OF THE INVENTION

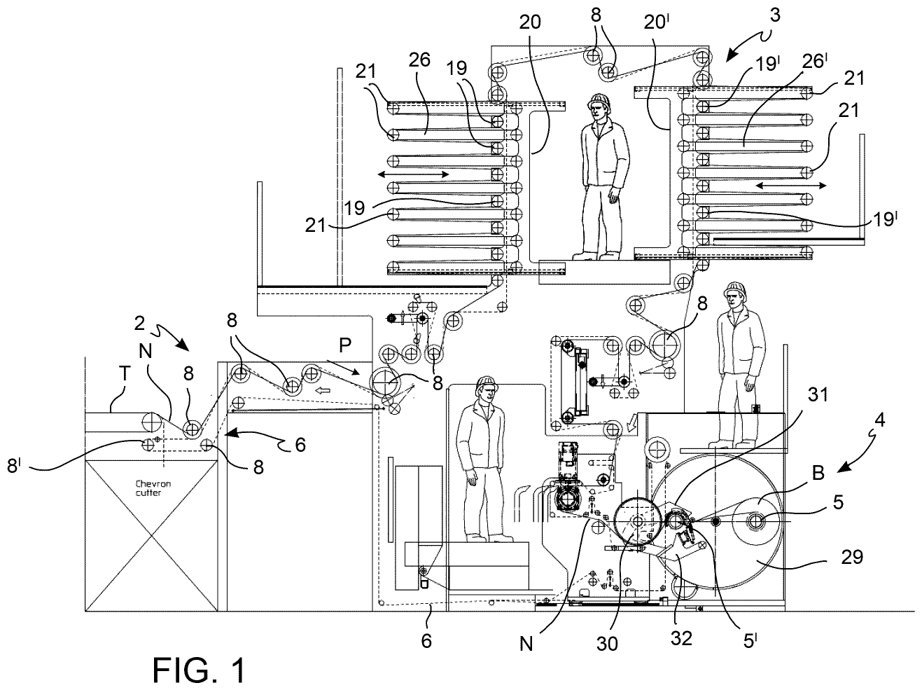

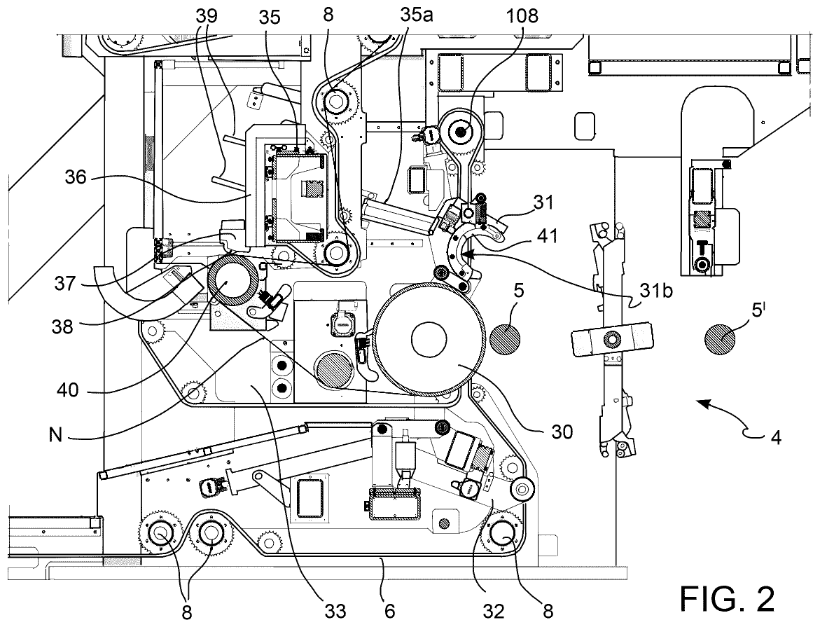

The converting machine according to the invention, indicated by reference numeral 1 as a whole, comprises a loading unit 2 of the strip N of material, an accumulation unit 3 of the strip N being processed, and a winding unit 4 of the strip N on a winding shaft 5, 5′ to form respective coils B. The loading unit 2 of the strip N comprises the accompanying system 6 for the strip N along the various working steps of the machine 1, i.e., from the loading unit 2 to the accumulation unit 3 and the winding unit 4. The accompanying system 6, shown in FIG. 1 with a dotted line, consists of a double chain (diagrammatically shown in the figures with a single line) which develops in a loop along a path P defined by a plurality of idle toothed wheels 8 and at least one motorized toothed wheel 8′. The double chain movably supports an accompanying bar 9, which is thus movable along the loop-shaped path P and is configured to drive the strip N to be loaded into the machine 1 from the loading unit 2 to the winding unit 4 and then, after releasing the strip N, to return to the starting point in the loading unit 2.

The accompanying bar 9 is preferably cylindrical in shape, i.e., it has a circular section or at least comprises a surface with an arc-of-a-circle-shaped section facing the sliding direction of the double chain. The accompanying bar 9 is also made of, or comprises parts made of, a ferromagnetic material so as to be subjected to attraction by a magnet.

The accompanying system 6 also comprises a non-motorized magnetic bar, which idly slides along the path P on appropriate guides and is configured to bP coupled to the accompanying bar 9 during the operating steps of the method of loading a new strip N.

in a first step of loading a new strip N, the strip N from a large coil upstream (not shown) is fed to the loading unit 2 of the machine 1 by means of a conveyor T and falls vertically positioning itself in the space between the accompanying bar 9 and the magnetic bar.

In the next step, the double chain is set in motion along the direction of the arrow, so that the accompanying bar 9 comes into contact with an end portion of the strip N until it is sandwiched between the accompanying bar 9 and the magnetic bar. The magnetic attraction between the magnetic bar and the accompanying bar 9 allows holding the strip N firmly close to one end thereof and leading it along the path P in a gentle manner, i.e., without the use of gripper systems which would damage the strip N and cause it to break.

The accompanying bar 9—magnetic bar assembly together with the strip N continues to travel along said path P. In practice, the strip N is driven by the accompanying bar 9 and the magnetic bar through the accumulation unit 3, then into the winding unit 4, where the end portion of the strip N is separated from the rest of the strip N, which then begins to be wound on a winding shaft 5, 5′, thus performing the converting operation. The accompanying bar 9 and the magnetic bar, associated with the piece S of strip N, continue along the path P to return to the loading unit 2, where the accompanying bar 9 is disassociated from the magnetic bar and returns to its initial position. The automatic loading system summarized above is described in detail in the co-pending Italian patent application n. 102022000014710 del 13/7/2022.

The accumulation unit 3 is placed between the loading unit 2 and the winding unit 4 of the strip N on a winding shaft 5, 5′. The accumulation unit 3 acts as a buffer store when it is necessary to replace a fully wound coil B in the winding unit 4 with a winding shaft 5′ to be wound. Such an operation requires a temporary stop of the winding, therefore the accumulation unit allows not interrupting the feeding of strip N from the conveyor T during such a stop.

The accumulation unit 3 comprises a first movable supporting structure 20 for a first series of movable rollers 21 and a second movable supporting structure 20′ for a second series of movable rollers 21′. Each series of movable rollers 21, 21′ comprises a plurality of vertically aligned rollers in a plane parallel to a first and a second straight path stretch. Said first and second straight path stretches are connected by a third upper path stretch, to form as a whole a substantially n-shaped stretch of path P, which encloses said movable supporting structures 20, 20′ of the movable rollers 21, 21′ underneath.

Each of the movable supporting structures 20, comprises a pair of comb-shaped supports arranged parallel to each other and each comprising a plurality of horizontal arms 26, 26′, where the horizontal arms 26, 26′ of the first pair of comb-shaped supports face the first straight stretch of path P and the horizontal arms 26′ of the second pair of comb-shaped supports face the second straight stretch of the path P.

The movable supporting structures 20, 20′ slide horizontally on appropriate shoes by means of an appropriate drive (not shown). The movable supporting structures 20, 20′ are movable in a mutually opposite direction between a retracted position, in which the movable rollers 21, 21′ are not in contact with the strip N, and a plurality of extended positions, in which the movable rollers 21, 21′ are in contact with the strip N.

The accumulation unit 3 further comprises a first series of fixed rollers 19 and a second series of fixed rollers 19′, facing the first and second series of movable rollers 21, 21′, respectively, but vertically staggered with respect thereto. Each series of fixed rollers 19, 19′ comprises a plurality of vertically aligned rollers, respectively, in a plane parallel to said first stretch and second stretch of the path P and facing one side of said path stretches opposite to the first and second series of movable rollers 21, 21′, i.e., outside of the n-shaped path stretch P, so that said path stretches are placed between said fixed rollers 19, 19′ and said movable rollers 21, 21′.

FIG. 1 shows the machine 1 in a normal operational condition. The movable rollers 21, 21′ are moved forward to an extended position, introducing themselves between two contiguous fixed rollers 19, 19′ and engaging the strip N so as to extend it to form meanders. The movement of the movable rollers 21, 21′ from the retracted position to an extended position and vice versa, as indicated by the arrows, allows modulating the total length of the path P as needed, either by lengthening it (movable rollers 21, 21′ in a more extended position) or shortening it (movable rollers 21, 21′ in a less extended position), so as to act as a storage buffer for the strip N during processing, in case of a processing stoppage or slowdown of the downstream in winding unit 4.

A particular embodiment of the accumulation unit 4 is described in detail in the co-pending Italian patent application N. 102022000014725 dated 13 Jul. 2022.

The winding unit 4 comprises a rotatable disc 29, which supports two winding shafts 5, 5′ of the coils B. In turn, the winding shafts 5, 5′ are rotatable by means of an appropriate motorization.

The winding unit 4 further comprises a feeding roller 30 of the strip N to a winding position, with which a movable member 31 accompanying the strip N and a cutting member 32 are operatively associated.

The winding shafts 5, 5′ are placed in opposite positions along a diameter of the disc 29, so that 180° rotation of the disc 29 allows taking the first winding shaft 5 or the second winding shaft 5′ alternatively to said winding position.

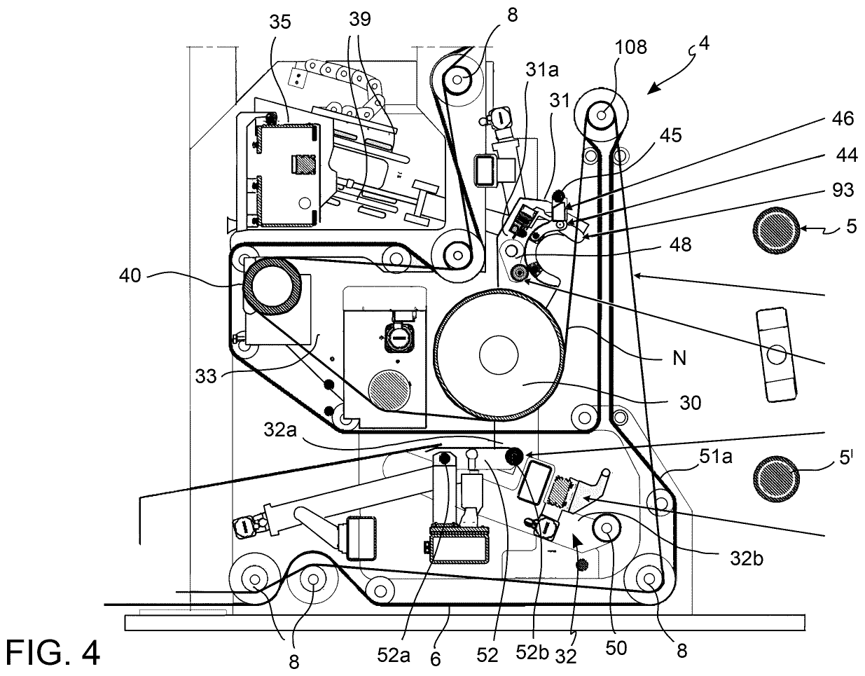

FIG. 4 shows in detail the mechanism of feeding roller 30, movable accompanying member 31, and the cutting member 32.

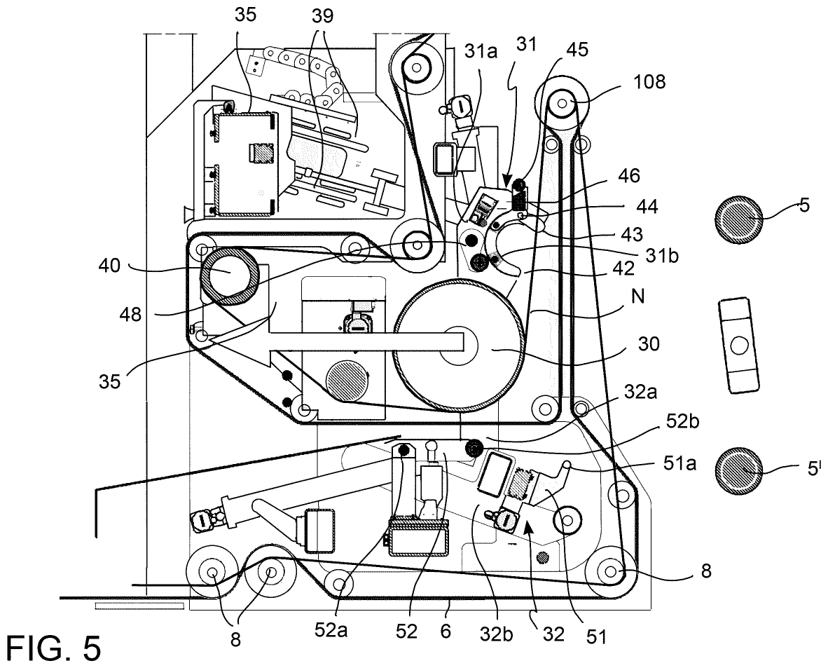

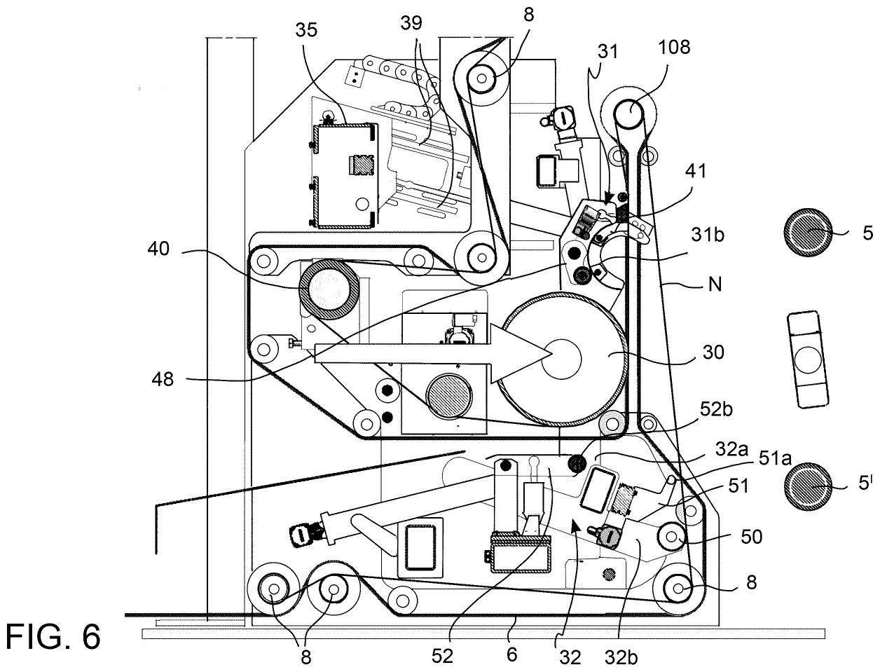

The feeding roller 30, the movable accompanying member 31, and the cutting member 32 are placed on a carriage 33, movable horizontally (as shown by the arrow in FIG. 5) between at least one forward or operating position (FIG. 6-13) and a retracted or resting position (FIG. 4-5).

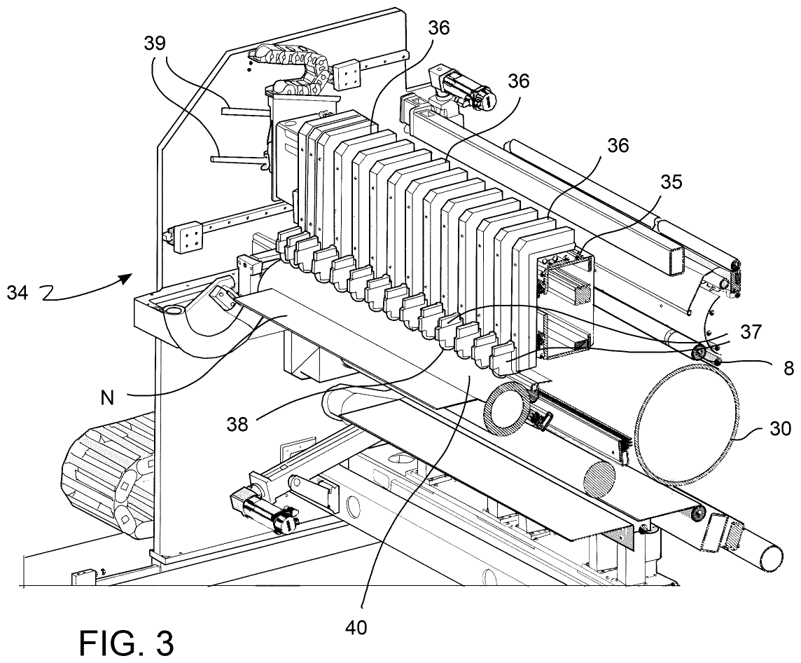

A longitudinal cutting assembly 34 of the strip N, also shown in FIG. 3, is also placed on the carriage 33. The longitudinal cutting assembly 34 is configured to cut the strip N fed to winding unit 4 according to its length, so as to reduce its width and ultimately obtain two or more coils B of rewound material N.

The longitudinal cutting assembly 34 comprises a crosswise supporting bar 35, to which a plurality of vertical supports 36 is fixed, with each of which a cutting device 37 can be associated. The number of cutting devices 37 is dictated by the number of width reductions of the strip N to be achieved. FIG. 3 shows a cutting device 37 for each vertical support 36, but in other cases, there may also be a single cutting device 37 placed in the middle of the width of the crosswise supporting bar 35, so as to divide the incoming strip N into only two strips to be rewound.

The cutting device 37 comprises a blade 38 vertically sliding by means of a pneumatic actuator (not shown) inside the cutting device 37. The blade 38 is a discoidal blade idly rotating on a supporting pin.

The crosswise supporting bar 35 is movable, by a pneumatic actuator 35a, along a track 39 arranged diagonally on the carriage 33, between a raised position and a lowered position.

The longitudinal cutting unit 34 further comprises a contrast cylinder 40, on which the strip

N slides and which, in operating condition, is tangential with the blade 38 of the cutting device 37. Such an operating condition is achieved by sliding the crosswise supporting bar 35 diagonally from the raised position to the lowered position and by sliding the blade 38 downward.

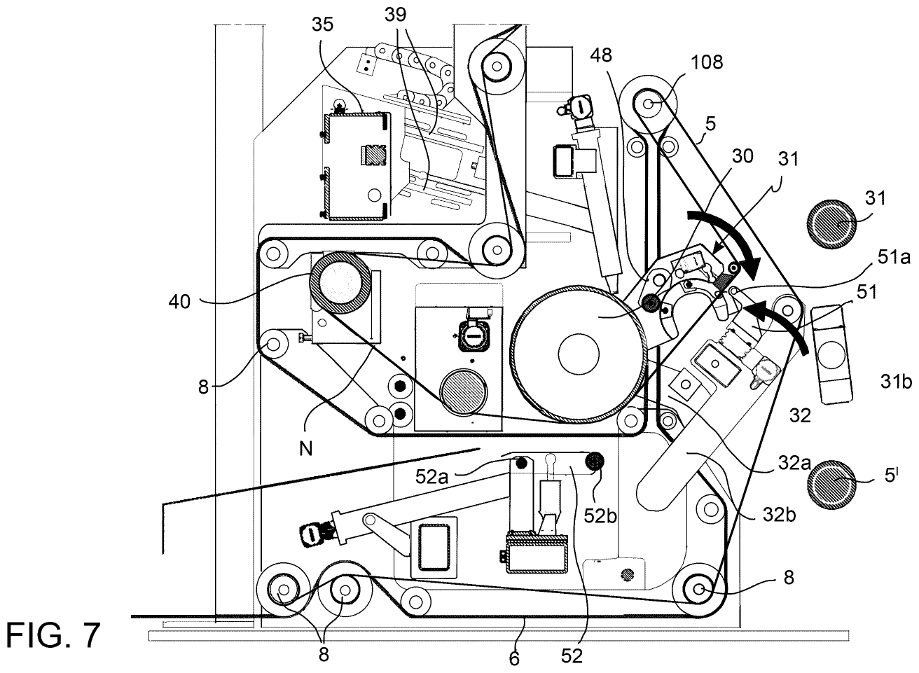

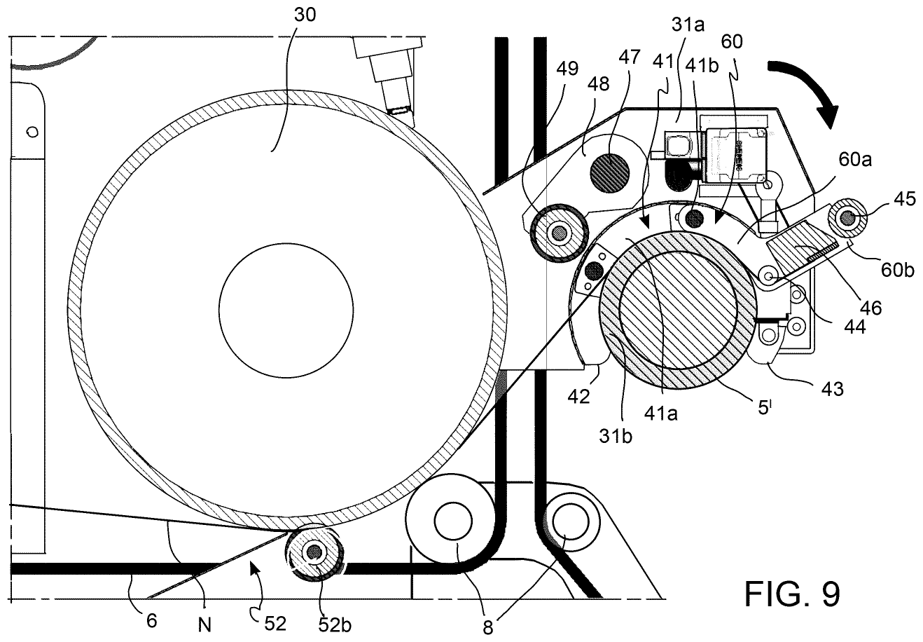

FIG. 4 shows the rewinding unit 4 in a non-operational condition. The movable accompanying member 31 is hinged on the axis of the feeding roller 30 and is tiltable between a non-operating position (for example, shown in FIG. 4) and an operating position (for example, shown in FIG. 7 or 9).

The movable accompanying member 31 comprises a body 31a having an arc-of-circle-shaped recess 31b of shape and size such as to be coupled to an at least semi-cylindrical portion of the surface of a winding shaft 5, 5′.

The recess 31b comprises a housing which develops along its entire extension and in which an accompanying element 41 of the strip N slides. The accompanying element 41 is movable between a retracted position and an extended position, in which, by sliding in said housing, it performs a rotation of about 180° about a rotation axis parallel to the rotation axis of the winding shafts 5, 5′.

As better shown in FIG. 9, the accompanying element 41 comprises a semicircular portion 41a, having a first end 42 and a second end 43. A hinge 41b is placed in an intermediate position between said ends 42, 43, on which a retaining element 60 is hinged, comprising, in turn, an arc-of-circle-shaped portion 60a and a protruding portion 60b, which extends along a direction substantially perpendicular to a tangent of the arc-of-circle-shaped portion 60a.

A holding roller 44 is placed at the junction point between said arc-of-circle-shaped portion 60a and said protruding portion 60b, while an idle roller is placed at the distal end of the protruding portion 60b.

The protruding portion 60b further comprises a suction/blowing grille 46, which can be alternately put into flow communication with suction means (not shown) or with a fan or compressed air source (not shown) by means of an appropriate two-way valve.

The retaining element 60 is tiltable between a retracted position (for example, shown in FIG. 9) and a lowered position (for example, shown in figure in which the arc-of-circle-shaped portion 60a of the retaining element 60 coincides with a sector of the semicircular portion 41a of the accompanying element 41.

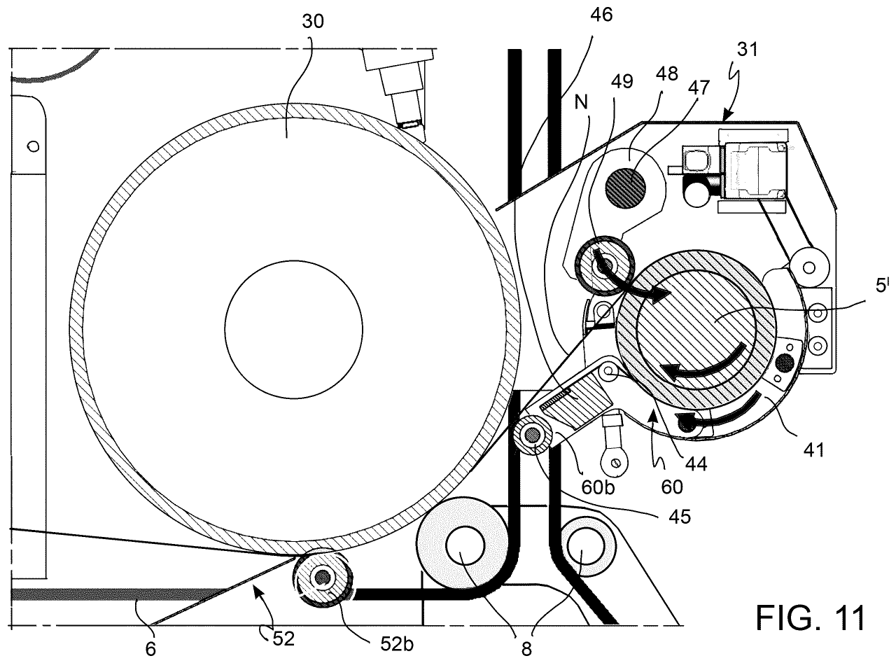

A tilting arm 48, which distally comprises a holding roller 49, is also hinged on a hinge 47 of the body 31a of the accompanying member 31. The tilting arm 48 is movable between a non-operating position (for example, shown in FIG. 9) and an operating position (for example, shown in FIG. 11), as will be further clarified below.

The cutting member 32 is tiltable between a non-operating position (for example, shown in FIG. 4) and an operating position (for example, shown in FIG. 7).

The cutting member 32 is also hinged on the axis of the feeding roller 30 by means of a connecting element 32a which extends in a substantially perpendicular direction to the body 32b. The body 32b extends along a longitudinal axis and comprises a holding roller 50 at one end, and adjacent thereto, a cutting device 51, which protrudes along a direction substantially perpendicular to the body 32b and carries a blade 51a at the distal end thereof. The cutting device 51 is placed on the side of the body 32b which, in the operating condition, faces the movable accompanying member 31 and is configured to abut against a surface of the latter when cutting the strip N.

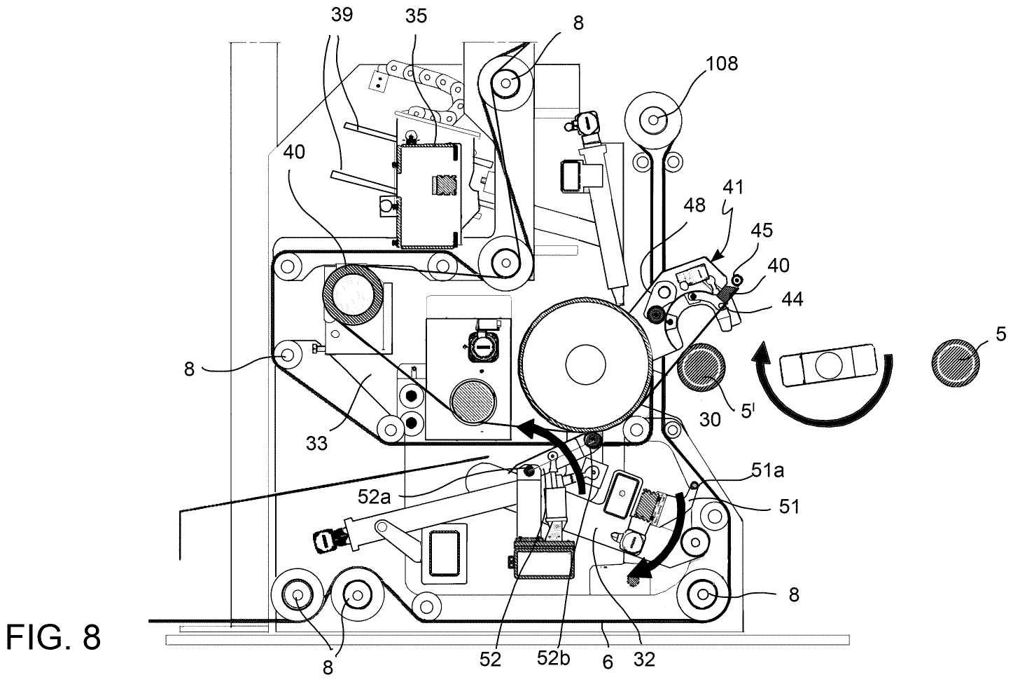

Moreover, a tilting arm 52 hinged at one end 52a and carrying a holding roller 52b at the opposite end is also placed on the carriage 33, below the feeding roller 30. The tilting arm 52 is movable between a non-operating position (for example, shown in FIG. 4) and an operating position (for example, shown in FIG. 8) in which it abuts against the feeding roller 30.

The feeding roller 30 and the winding shafts 5, are motorized. The movements of accompanying member 31, accompanying element 41, tilting arm 48, retaining element 60, and cutting member 32 are actuated by suitable electric or pneumatic actuators.

The strip N of material to be rewound, coming from the accumulation unit 3 and reduced in width by passing through the longitudinal cutting unit 34, is slid at an idle roller 108 placed laterally and at a higher position with respect to the feeding roller 30. The strip N, possibly divided in width into two or more strips, thus faces the accompanying member 31 and is included between the latter and the cutting member 32.

FIGS. 5-13 show an operational sequence of automatically starting (or restarting) the winding of a coil of material.

As described above, the strip N is driven by the accompanying system 6 into the rewinding unit 4. FIG. 5 shows the step in which the feeding roller placed on the carriage 33 is in the retracted position and the strip N has already passed over the feeding roller 30 and the idle roller 108.

FIG. 6 shows the next step in which the carriage 33 is in an operating forward position. In the immediately following step, shown in FIG. 7, the accompanying member 31 and the cutting member 32 are tilted until they abut, so as to cut the strip N, thus generating the piece S which will be removed as described above. It is worth noting that, during the cutting operation, the strip N is bent and stretched by sliding on the holding roller 44 and the idle roller 45 of the retaining element 60. Similarly, downstream of the accompanying member 31, the strip N is bent and stretched by passing through the holding roller 50 of the cutting member 32.

FIG. 8 shows the step in which the cutting member 32 is returned to the non-operating position, while the accompanying member 31 holds the end of the strip N to be rewound by virtue of the activation of the suction grille 46 and the simultaneous rotation of the tilting arm 52 of the carriage 33 so as to apply a sealing pressure to the feeding roller 30 by means of the respective holding roller 52b. The disc 29 (FIG. 1) is also rotated clockwise to take a winding shaft 5′ close to the accompanying member 31. FIG. 9 shows the next step in which the accompanying member 31 is further rotated to a second operating position so that the arc-of-circle-shaped recess 31b accommodates the winding shaft 5′ by positive coupling.

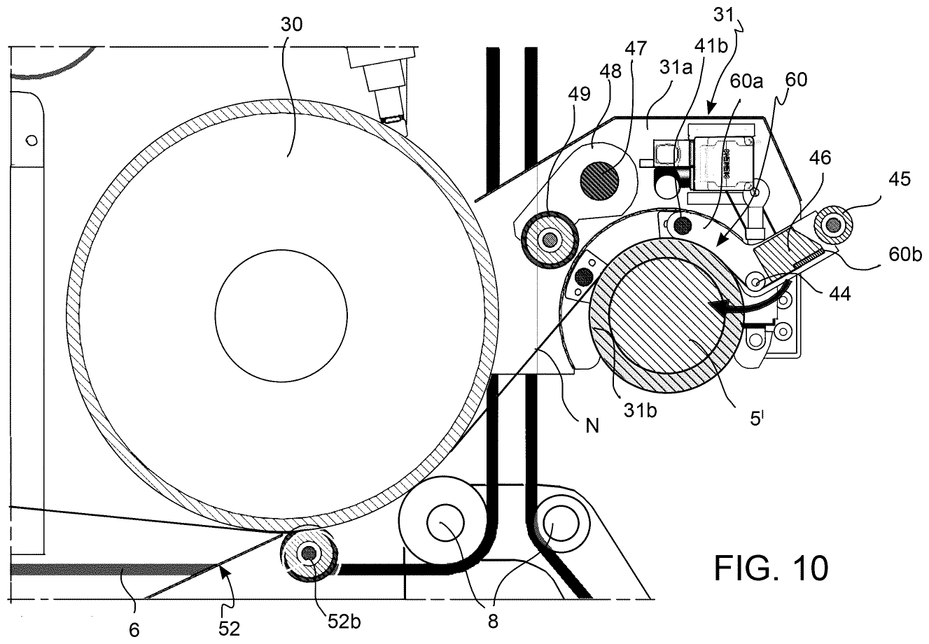

The next step, shown in FIG. 10, includes moving the retaining element 60 from the retracted position to the lowered position so that the holding roller 44 thereof presses against the surface of the winding shaft 5′, thus helping to keep the strip N (i.e., the plurality of strips resulting from its longitudinal cut) adhered to the winding shaft 5′.

As shown in FIG. 11, the next step includes, according to the arrows shown in the figure, synchronously rotating:
the winding shaft 5′,
the tilting arm 48 so as to press the respective holding roller 49 against the winding shaft 5′,
the accompanying element 41 so as to encircle the entire circumference of the winding shaft 5′ with the accompanying element 41 and the recess 31b of the accompanying member 31.

The strip N (i.e., the plurality of strips resulting from its longitudinal cut) is thus accompanied in the initial winding thereof around the winding shaft 5′, being held against its surface by the holding rollers 44, 49, and by the suction of the free end thereof by means of the suction grille 46.

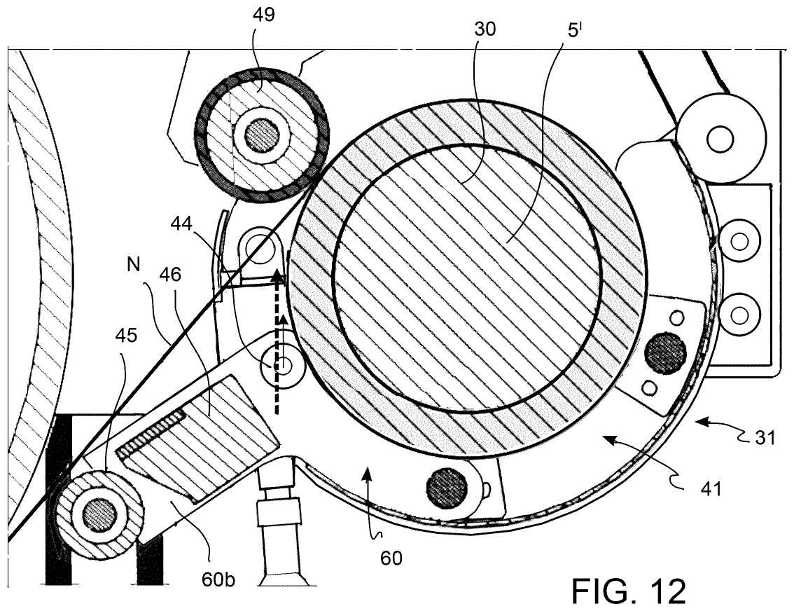

FIG. 12 shows the next step, in which the suction by the grille 46 is suspended and the grille 46 is connected to a pressurized air source which provides a release of the free end of the strip, taking it to adhere onto the winding shaft 5′. The winding shaft 5′ continues to rotate, thus starting the rewinding operation.

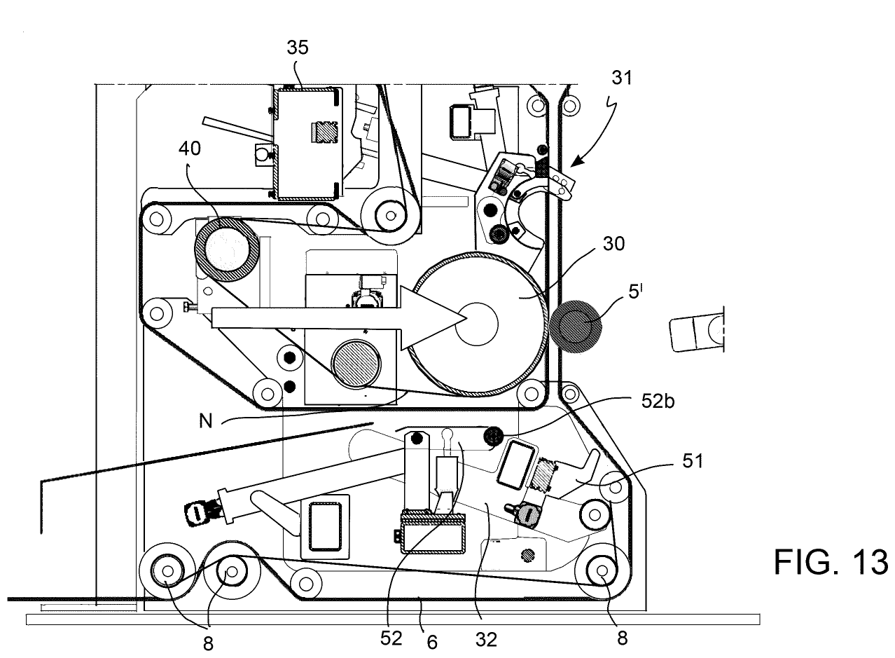

Finally, FIG. 13 shows the final step in which the accompanying member 31 is returned to the non-operating position, and the carriage 33 is further moved forward to a further operating position in which it abuts against the winding shaft 5′ to keep the strip N in contact therewith.

The converting machine according to the present invention thus allows achieving the initially set objects since the winding system described above, in the case of a change of coil or breakage of the strip to be wound, allows for complete automation, without any human intervention, and is also particularly suitable if the strip is made of a particularly brittle material, especially by virtue of the accompanying member.

The machine 1 according to the invention allows for an automatic restarti g after breakage or cr change without us dhesive tape or glue (of any nature). By avoidi j the Use of adhesives (thus chemical contaminants), it is also possible to process materials intended for the food industry.

It is apparent that only some particular embodiments of the present invention have been described, to which those skilled in the art will bP able to make all changes required for the adaptation thereof to particular applications, without departing from the scope of protection of the present invention.

What we claim is:

1. A machine for converting coils of a material into coils of smaller size, comprising a loading unit for loading a strip of material into the machine, an accumulation unit of the strip being processed, and a winding unit of the strip on a winding shaft to form respective coils, characterized in that the winding unit comprises:
a revolving disc, which supports two winding shafts of coils;
a feeding roller of the strip to a winding position;
a movable accompanying member of the strip and a cutting member associated in an operating manner with said feeding roller,
wherein the feeding roller, the movable accompanying member, and the cutting member are placed on a carriage, movable horizontally between at least one forward or operating position and a retracted or resting position;
and wherein the movable accompanying member and the cutting member are hinged on the feeding roller axis and are tiltable between a non-operating position and an operating position adapted to operate the crosswise cut of the strip.

2. The machine according to claim 1, wherein the movable accompanying member comprises a body having an arc-of-circle-shaped recess of shape and size such to couple with an at least semi-cylindrical portion of the surface of a winding shaft.

3. The machine according to claim 2, wherein the recess comprises a housing which develops along its entire extension and in which an accompanying element of the strip slides, the accompanying element being movable between a retracted position and an extended position, in which, by sliding in said housing, it performs a rotation of about 180° about a rotation axis parallel to the rotation axis of the winding shafts.

4. The machine according to claim 3, wherein the accompanying element comprises a semicircular portion having a first end and a second end, a hinge being placed in an intermediate position between said ends, on which hinge a retaining element is hinged, comprising, in turn, an arc-of-circle-shaped portion and a protruding portion, which extends along a direction substantially perpendicular to a tangent of the arc-of-circle-shaped portion, wherein, a holding roller is placed at the junction point between said arc-of-circle-shaped portion and said protruding portion, and an idle roller is placed at the distal end of the protruding portion; and wherein the protruding portion comprises a suction/blowing grille, which is alternately in flow communication with suction means or with a fan or source of compressed air; the retaining element being tiltable between a retracted position and a lowered position, in which the arc-of-circle-shaped portion of the retaining element coincides with a sector of the semicircular portion of the accompanying element.

5. The machine according to claim 2, wherein the accompanying member comprises a tilting arm, which distally comprises a holding roller, and which is movable between a non-operating position and an operating position, in which the holding roller insists on a winding shaft.

6. The machine according to claim 1, wherein the cutting member comprises a blade located on a side of the cutting member which, in an operating condition, faces the movable accompanying member and is configured to abut on a surface of the latter during the cutting of the strip.

7. The machine according to claim 6, wherein the cutting device comprises a body, which extends along a longitudinal axis and comprises a holding roller at one end and, adjacent thereto, a cutting device, which protrudes along a direction substantially perpendicular to the body and carries said blade at its distal end.

8. The machine according to claim 1, wherein the carriage comprises a tilting arm carrying a holding roller at one end, the tilting arm being movable between a non-operating position and an operating position in which the holding roller abuts against the feeding roller.

9. The machine according to claim 1, wherein the carriage comprises a longitudinal cutting assembly of the strip, configured to cut the strip fed to the winding unit according to its length, so as to reduce its width and ultimately obtain two or more coils of rewound material, said longitudinal cutting assembly comprising a crosswise supporting bar comprising one or more cutting devices, wherein each cutting device comprises a vertically sliding blade, the blade preferably being a discoidal blade rotating in an idle manner, and wherein the crosswise supporting bar is movable along a track arranged diagonally on the carriage, between a raised position and a lowered position, the longitudinal cutting assembly further comprising a contrast cylinder, on which the strip is intended to slide and which, in operating condition, is tangential with the blade of the cutting device.

10. The machine according to claim 1, wherein the winding unit comprises an idle roller placed laterally and at a higher position relative to the feeding roller, said idle roller being configured to outline a path of the strip, or of the plurality of strips originated by the longitudinal cutting unit, so that it faces the accompanying member and is comprised between the latter and the cutting member.

11. The machine according to claim 4, wherein the feeding roller and winding shafts are motorized and wherein the movements of the accompanying member, of the accompanying element, of the tilting arm, of the retaining element and of the cutting member are actuated by electric or pneumatic actuators.
